(19) United States
(12) Patent Application Publication
(10) Pub. No.: US 2001/0056136 A1
(43) Pub. Date: Dec. 27, 2001

(54) Polymer composite

(75) Inventors: Naoki Hasegawa, Aichi-gun (JP); Azusa Tsukigase, Aichi-gun (JP); Arimitsu Usuki, Aichi-gun (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOYOTA CHUO KENKYUSHO, Aichi-gun (JP)

(21) Appl. No.: 09/730,595

(22) Filed: Dec. 7, 2000

(30) Foreign Application Priority Data
Dec. 10, 1999 (JP) P1999-351989
Mar. 31, 2000 (JP) P2000-099703

(51) Int. Cl. C08K 3/34; C08K 9/00

(52) U.S. Cl. 523/205; 523/216; 523/207; 524/445

(57) ABSTRACT

Provided is a polymer composite comprising a polymer and a layered clay mineral dispersed in the polymer, the layered clay mineral being a layered clay mineral organized by an organizing agent in an amount of 25% to 85% based on total cation exchange capacity of the layered clay mineral, or by an organizing agent comprising an organic polyonium compound. In such a polymer composite, even when the polymer employed is a polar polymer, the dispersibility of layered clay mineral is favorable, and physical properties such as mechanical properties and gas barrier property are excellent.

### BACKGROUND OF THE INVENTION

1. Field of the Invention

The present invention relates to a polymer composite comprising an organized layered clay mineral.

2. Related Background Art

In order to improve mechanical properties, rigidity, and the like of polymers, layered clay minerals such as kaolinite and montmorillonite have conventionally been added thereto. Since the layered clay minerals in their original state are hard to finely disperse into a polymer, attempts have been made to improve their dispersibility by processing them with various compounds before being added to the polymer.

For example, Japanese Patent Application Laid-Open No. HEI 9-217012 states that, when a layered clay mineral in which an organic substance having an onium ion (organic onium compound) is intercalated as an organizing agent between layers is added to a thermoplastic resin, the layered clay mineral can finely be dispersed in the thermoplastic resin. In this publication, an organic monoonium compound is used as the organizing agent, and an excess amount of organizing agent (by an amount of about 2.5 times the total cation exchange capacity of the layered clay mineral) is added to the layered clay mineral in order to obtain the layered clay mineral in which the organizing agent is intercalted between layers.

On the other hand, Japanese Patent Application Laid-Open No. HEI 10-1608 discloses that properties of a polyamide resin such as the gas barrier property thereof can be improved when a layered silicate incorporating therein a quaternary onium ion (organizing agent) having at least 8 carbons is added to the polyamide resin. An organic monoonium compound is used as the organizing agent in this publication as well, whereas the amount of use of the organizing agent is 1.2 times the total cation exchange capacity of layered silicate.

Thus, when processing a layered clay mineral with an organic monoonium compound, the latter comprising a long-chain organic group having about 6 to 20 carbons is added to the former by an amount which is at least 1 times the total cation exchange capacity of layered clay mineral in general.

Known as the method of processing a layered clay mineral are not only those mentioned above, but also a method disclosed in Japanese Patent Application Laid-Open No. SHO 52-33931 in which the particle surface of layered clay mineral is coated with an N-oxyalkyl polyamine compound.

### SUMMARY OF THE INVENTION

Though the cases disclosed in Japanese Patent Application Laid-Open No. HEI 9-217012 and No. HEI 10-1608 using organized layered clay minerals improve the dispersion in polymers as compared with the case using unorganized layered clay minerals, they have not always been sufficient in terms of the fineness in dispersion and have generated a problem that the state of dispersion varies depending on the kind of polymers, the amount of addition, and the like. As a consequence, there have been cases where physical properties, such as mechanical properties and gas barrier property, of polymers having a layered clay mineral added thereto become insufficient.

Also, as the ion exchange of layered clay mineral advances, the concentration of long-chain organic group between layers increases, thereby enhancing the hydrophobic property of layered clay mineral as a whole, which restricts the kind of polymers capable of achieving fine dispersion to those having a high hydrophobic property. Therefore, dispersibility has been insufficient in polar polymers, for example.

On the other hand, atoms in the N-oxyalkyl polyamine compound used in the method disclosed in Japanese Patent Application Laid-Open No. SHO 52-33931 are not ionized. As a consequence, if a layered clay mineral is processed with the N-oxyalkyl polyamine compound, this compound mainly adheres to the surface of layered clay mineral particles and hardly intercalates between layers of the layered clay mineral. Therefore, in the case where thus processed layered clay mineral is dispersed in a polymer, there has been a problem that the infiltration (intercalation) of polymer between layers of the layered clay mineral is difficult, so that the fine dispersion of layered clay mineral cannot be achieved.

In view of such technical problems, it is an object of the present invention to provide a polymer composite comprising a polymer and a layered clay mineral, in which, even when the polymer is a polar polymer, the dispersibility of layered clay mineral is favorable, and physical properties such as mechanical properties and gas barrier property are excellent.

The inventors have repeated diligent studies in order to achieve the above-mentioned object and, as a result, have found that a method using a layered clay mineral in which only a part of total cation exchange capacity thereof is organized by an organizing agent or a method using a layered clay mineral organized by an organizing agent comprising an organic polyonium compound can yield a polymer composite in which the layered clay mineral is quite finely dispersed even in a polar polymer, thereby accomplishing the present invention.

Namely, the polymer composite of the present invention comprises a polymer and a layered clay mineral dispersed in the polymer, the layered clay mineral being a layered clay mineral organized by an organizing agent in an amount of 25% to 85% based on total cation exchange capacity of the layered clay mineral.

While layered clay minerals have inorganic cations such as sodium ion between layers, a layered clay mineral organized by an organizing agent in an amount of 25% to 85% based on total cation exchange capacity of the layered clay mineral would have both the cations originally contained therein and the organizing agent between layers. The polarity of layered clay mineral decreases as the ratio of organization caused by the organizing agent increases, whereas the polarity of layered clay mineral increases as the ratio of organization decreases. If the ratio of organization is controlled so as to become 25% to 85% of total cation exchange capacity, then the polarity of layered clay mineral can be made closer to the polarity of various kinds of polymers such as polar polymers, so that the affinity therebetween would improve, thereby allowing the layered clay mineral to finely disperse. Since the interlayer distance increases when the organizing agent exists therebetween, the infiltration (intercalation) of polymer between layers becomes easier, whereby the contact area between the layered clay mineral and polymer increases. As a result, physical properties, such as mechanical properties and gas barrier property, of thus obtained polymer composite improve.

In the present invention, the organizing agent for organizing the layered clay mineral is preferably an organic onium compound, whereas the organic onium compound is preferably at least one compound selected from the group consisting of an organic ammonium compound, an organic phosphonium compound, an organic pyridinium compound, and an organic sulfonium compound. Also, the organic onium compound is preferably an organic ammonium compound comprising at least one organic chain having 4 to 30 carbons.

Since the organic onium compound is excellent in reactivity with layered clay minerals, it becomes easier to obtain a layered clay mineral in which 25% to 85% of total cation exchange capacity is organized. Also, the intercalation of polymer becomes favorable in the layered clay mineral organized by the organic onium compound. Therefore, physical properties, such as mechanical properties and gas barrier property, of the polymer composite tend to improve when the organic onium compound is used.

Also, the present invention provides a polymer composite comprising a polymer and a layered clay mineral dispersed in the polymer, the layered clay mineral being a layered clay mineral organized by an organizing agent comprising an organic polyonium compound.

When organization is effected by use of an organizing agent comprising an organic polyonium compound, one molecule of organizing agent can carry out ion exchange of a plurality of metal ions (such as sodium ion) existing between layers of the layered clay mineral. Therefore, even when the whole amount of metal ions in the layered clay mineral is replaced with the organizing agent by ion exchange, the amount of organic groups introduced between the layers decreases, thus suppressing the improvement in hydrophobic property (decrease in polarity) as the whole layered clay mineral. Also, changing the amount of organic polyonium compound in use can control the polarity of organized layered clay mineral. As a consequence, the affinity between the layered clay mineral and various polymers including polar polymers improves, thereby achieving an improvement in dispersibility.

Preferably, in the present invention, the organic polyonium compound is an organic polyonium compound having a number average molecular weight of 1,000 or less, the organic polyonium compound having a content of from 5% to 25% by weight based on the organized layered clay mineral.

In the case where the organic polyonium compound has the number average molecular weight mentioned above, the compatibility of organic polyonium compound with polymers improves, whereby the dispersibility of organized layered clay mineral tends to improve. When the content of organic polyonium compound is within the above-mentioned range, the polarity of organized layered clay mineral approaches the polarity of many polymers including polar polymers, whereby the dispersibility of layered clay mineral tends to improve.

In the present invention, the organic polyonium compound is preferably a compound comprising at least two onium ion atoms, an intramolecular organic chain having 1 to 4 carbons connecting the onium ion atoms to each other, and terminal organic chains having 1 to 24 carbons connected to the onium ion atoms, at least one of the terminal organic chains being an organic chain having 6 to 24 carbons.

When the organic polyonium compound has the configuration mentioned above, molecules of the organic polyonium compound would have a hydrophobic portion (lower polarity portion) composed of a long-chain organic group and a polar portion in which a plurality of onium ion atoms are assembled at intervals of 1 to 4 carbons. Since the polar portion combines with the surface of each layer of the layered clay mineral upon ion exchange, and the hydrophobic portion is oriented between layers of the layered clay mineral, it becomes easier to enhance the interlayer distance of layered clay mineral, so that the amount of polymer infiltrating therein upon intercalation increases, whereby the dispersibility of layered clay mineral tends to improve.

In the present invention, the number of onium ion atoms in the organic polyonium compound is preferably 2 to 5. In the case where the number of onium ion atoms in the organic polyonium compound is within the range mentioned above, one molecule of organic polyonium compound is less likely to combine with two or more layers of layered clay mineral, so that two or more layers are not constrained by one molecule of organic polyonium compound, whereby the dispersibility of layered clay mineral can further be improved.

Preferably, in the present invention, the organic polyonium compound is a compound represented by the following general formula (1) or a compound represented by the following general formula (2):

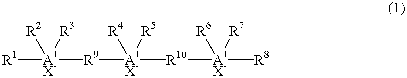

wherein A⁺ is an ion selected from the group consisting of nitrogen ion and phosphorus ion; R¹, R², R³, R⁴, R⁵, R⁶, R⁷, and R⁸ may be the same or different and each represents a member selected from the group consisting of a monovalent organic chain having 1 to 24 carbons and hydrogen atom, with the proviso that at least one of R¹, R², R³, R⁴, R⁵, R⁶, R⁷, and R⁸ must be a monovalent organic chain having 6 to 24 carbons; R⁹ and R¹⁰ may be the same or different and each represents a divalent organic chain having 1 to 4 carbons; and X⁻ represents an anion;

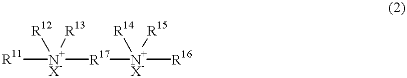

wherein R¹¹, R¹², R¹³, R¹⁴, R¹⁵, and R¹⁶ may be the same or different and each represents a member selected from the group consisting of a monovalent organic chain having 1 to 24 carbons and hydrogen atom, with the proviso that at least one of R¹¹, R¹², R¹³, R¹⁴, R¹⁵, and R¹⁶ must be a monovalent organic chain having 6 to 24 carbons; R¹⁷ represents a divalent organic chain having 1 to 4 carbons; and X⁻ represents an anion.

Preferably, in the present invention, the organizing agent comprising an organic polyonium compound further comprises an organic monoonium compound. When the organizing agent comprises an organic polyonium compound and an organic monoonium compound, the control of polarity in the layered clay mineral tends to be easier.

Preferably, the polymer included in the polymer composite of the present invention is a polar polymer. The polymer included in the polymer composite is preferably a polymer having a solubility parameter of 9 (cal/cm³)^{½} or greater, and is preferably a polymer having a nitrile group and/or hydroxyl group.

Since the polymer having a solubility parameter of 9 (cal/cm³)^{½} or greater and the polymer having a nitrile group and/or hydroxyl group are polar polymers, whereas a layered clay mineral organized by an organizing agent in an amount of 25% to 85% based on total cation exchange capacity of the layered clay mineral and a layered clay mineral organized by an organizing agent comprising an organic polyonium compound are excellent in affinity with such polar polymers in particular, the dispersibility of layered clay mineral tends to improve further. Therefore, physical properties, such as mechanical properties and gas barrier property, of the polymer composite tend to become excellent in particular.

The present invention will become more fully understood from the detailed description given hereinbelow and the accompanying drawings which are given by way of illustration only, and thus are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a chart showing an X-ray diffraction pattern of the polymer composite obtained in Example 1;

FIG. 2 is a chart showing an X-ray diffraction pattern of the polymer composite obtained in Example 2;

FIG. 3 is a chart showing an X-ray diffraction pattern of the polymer composite obtained in Comparative Example 1;

FIG. 4 is a chart showing an X-ray diffraction pattern of the polymer composite obtained in Comparative Example 2;

FIG. 5 is a chart showing an X-ray diffraction pattern of the polymer composite obtained in Example 3;

FIG. 6 is a chart showing an X-ray diffraction pattern of the polymer composite obtained in Example 4;

FIG. 7 is a chart showing an X-ray diffraction pattern of the polymer composite obtained in Comparative Example 3;

FIG. 8 is a chart showing an X-ray diffraction pattern of the polymer composite obtained in Comparative Example 4;

FIG. 9 is a chart showing an X-ray diffraction pattern of the polymer composite obtained in Example 5;

FIG. 10 is a chart showing an X-ray diffraction pattern of the polymer composite obtained in Example 6;

FIG. 11 is a chart showing an X-ray diffraction pattern of the polymer composite obtained in Comparative Example 5;

FIG. 12 is a chart showing an X-ray diffraction pattern of the polymer composite obtained in Comparative Example 6;

FIG. 13 is a chart showing an X-ray diffraction pattern of the vulcanized composite obtained in Example 7;

FIG. 14 is a chart showing an X-ray diffraction pattern of the vulcanized composite obtained in Example 8;

FIG. 15 is a chart showing an X-ray diffraction pattern of the vulcanized composite obtained in Comparative Example 7;

FIG. 16 is a chart showing an X-ray diffraction pattern of the vulcanized composite obtained in Comparative Example 8;

FIG. 17 is a chart showing an X-ray diffraction pattern of the polymer composite obtained in Example 9;

FIG. 18 is a chart showing an X-ray diffraction pattern of the mixture obtained in Comparative Example 10;

FIG. 19 is a view schematically showing a layered clay mineral organized by an organic polyonium compound; and

FIG. 20 is a view schematically showing a layered clay mineral organized by an organic monoonium compound.

### DESCRIPTION OF THE PREFERRED EMBODIMENTS

As mentioned above, the inventors have found that a method using a layered clay mineral in which only a part of total cation exchange capacity thereof is organized by an organizing agent (hereinafter referred to as the first embodiment of the present invention) or a method using a layered clay mineral organized by an organizing agent comprising an organic polyonium compound (hereinafter referred to as the second embodiment of the present invention) can yield a polymer composite in which the layered clay mineral is quite finely dispersed even in a polar polymer. Each of these embodiments will be explained in detail in the following.

The polymer composite in accordance with the first embodiment of the present invention is a composite comprising a polymer and a layered clay mineral dispersed in the polymer, the layered clay mineral being a layered clay mineral organized by an organizing agent in an amount of 25% to 85% based on total cation exchange capacity of the layered clay mineral.

The layered clay mineral employed in the first embodiment of the present invention is not restricted in particular, whereby layered clay minerals such as those of kaolinite family exemplified by kaolinite and halloysite; smectite family exemplified by montmorillonite, beidellite, saponite, hectorite, and mica; and vermiculite family can be used. The layered clay mineral may be any of those derived from natural products, processed natural products, and synthetic products such as fluorinated mica having a swelling property. The above-mentioned layered clay minerals may be used alone or in a mixture of two or more kinds.

Though not restricted in particular, the total cation exchange capacity of layered clay mineral is preferably 10 to 300 meq/100 g, more preferably 50 to 200 meq/100 g. Here, the total cation exchange capacity refers to the value computed by the column permeation method described in the following.

Namely, a filtering layer of 5 mm is made by absorbent cotton and a filter paper liquid in a leaching tube having a length of 12 cm and an inside diameter of 1.3 cm, and 0.2 to 1 g of layered clay mineral is packed thereon together with silica particles, whereas 100 ml of 1-N ammonium acetate solution are caused to infiltrate therein for 4 to 20 hours, so as to yield a layered clay mineral saturated with ammonium ion. The resulting product is washed with 100 ml of 10% brine, so that ammonium ion leaches out upon exchange. Then, the ammonium ion content is measured, and the milligram equivalent (meq) of cation per 100 g of layered clay mineral is computed from thus measured value and is defined as the total cation exchange capacity.

While the polymer composite in accordance with the first embodiment of the present invention comprises a layered clay mineral wherein 25% to 85% of thus computed total cation exchange capacity value is organized by an organizing agent, the organization by the organizing agent is preferably 40% to 75% of total cation exchange capacity. In the present invention, the organization refers to causing an organic substance to be adsorbed and/or combined to a surface of or between layers of the layered clay mineral by a physical or chemical method. The organizing agent refers to an organic substance capable of such absorption and/or combining; and an organic compound having a polar group, adapted to yield an ion in a solvent, and an organic group is usually employed. Therefore, the state where 25% to 85% of total cation exchange capacity is organized means that, when the total cation exchange capacity of layered clay mineral is 100 meq/100 g, 25 to 85 milliequivalents of cation ion in 100 g of layered clay mineral is replaced with the same equivalent of organizing agent.

Though the kind of organizing agent is not restricted in particular, an organic onium compound is preferably used from the viewpoint of its excellent reactivity with the layered clay mineral, and the like. Examples of the organic onium compound include organic ammonium compounds, organic phosphonium compounds, organic pyridinium compounds, and organic sulfonium compounds; among which the organic ammonium compounds and organic phosphonium compounds are more preferably used since the reactivity of their resulting organic onium ions is favorable.

Though the number of carbons in the organic chains combining with the onium ion atom (an atom having a lone pair, e.g., N⁺ atom in an organic ammonium compound) is not restricted in particular, the number of carbons in the organic chain in the longest chain is preferably 4 to 30, more preferably 6 to 24. As the organic onium compound, one comprising at least one organic chain having 4 to 30 carbons is preferable in particular. The effect of organizing the layered clay mineral tends to be insufficient if the carbon number of the longest chain is less than 4, whereas the dispersion of layered clay mineral in the polymer tends to be insufficient if this number exceeds 30. The number of organic chains combining with the onium ion atom in the organic onium compound is at least 1 but not greater than the maximum number permitted to combine therewith. This organic chain may have a substituent such as carboxyl group, hydroxyl group, thiol group, and nitrile group.

The organic ammonium compound employed as the organizing agent may be any of primary, secondary, tertiary, and quaternary ammonium compounds. Examples of such an ammonium compound include hexyl ammonium compounds, octyl ammonium compounds, decyl ammonium compounds, dodecyl ammonium compounds, tetradecyl ammonium compounds, hexadecyl ammonium compounds, octadecyl ammonium compounds, hexyl trimethyl ammonium compounds, octyl trimethyl ammonium compounds, decyl trimethyl ammonium compounds, dodecyl trimethyl ammonium compounds, tetradecyl trimethyl ammonium compounds, hexadecyl trimethyl ammonium compounds, octadecyl trimethyl ammonium compounds, dodecyl dimethyl ammonium compounds, dodecyl methyl ammonium compounds, dioctadecyl ammonium compounds, and dioctadecyl dimethyl ammonium compounds. These organic ammonium compounds may be used alone or in combination of two or more kinds.

The organization of layered clay mineral can be carried out by the method disclosed in Japanese Patent No. 2627194 assigned to the present applicant, for example. Namely, it can be achieved by ion exchange of inorganic ions such as sodium ion in the layered clay mineral with organic onium ions generated from the organic onium compound (e.g., organic ammonium ion in an organic ammonium compound). If the equivalent of organic onium compound added here is set to 25% to 85% of the total cation exchange capacity obtained by the method mentioned above, then a layered clay mineral organized by the organizing agent in an amount of 25% to 85% based on total cation exchange capacity of the layered clay mineral can be obtained.

In the case where an organic ammonium compound is used as the organic onium compound, organization can be carried out by the following method, for example. Namely, in the case where the layered clay mineral is shaped like a mass, it is initially pulverized into powder with a ball mill or the like. Subsequently, this powder is dispersed into water by use of a mixer or the like, so as to yield an aqueous dispersion of layered clay mineral. Separately, an acid such as hydrochloric acid and an organic amine are added to water, so as to prepare an aqueous solution of organic ammonium compound. This aqueous solution is added to and mixed with the aqueous dispersion of layered clay mineral such that the equivalent of organic ammonium compound becomes 25% to 85% of total cation exchange capacity. As a consequence, the inorganic cation in layered clay mineral is exchanged with the organic ammonium ion. Then, water is removed from this mixture by filtration, whereby a layered clay mineral organized in an amount of 25% to 85% based on total cation exchange capacity of the layered clay mineral can be obtained. As the dispersion medium for the organic ammonium compound and layered clay mineral, not only water but also methanol, ethanol, propanol, isopropanol, and ethylene glycol, their mixtures, mixtures of these and water, and the like can be used.

As mentioned above, the total cation exchange capacity of layered clay mineral is preferably 10 to 300 meq/100 g. If 25% to 85% of this total cation exchange capacity is organized, then the equivalent of cation left unorganized, such as sodium ion, becomes 1.5 to 225 meq/100 g.

The polymer composite in accordance with the second embodiment of the present invention is a composite comprising a polymer and a layered clay mineral dispersed in the polymer, the layered clay mineral being a layered clay mineral organized by an organizing agent comprising an organic polyonium compound.

The layered clay mineral usable in the second embodiment of the present invention is similar to that used in the first embodiment of the present invention. Also, the total cation exchange capacity of layered clay mineral in the second embodiment of the present invention is similar to that in the first embodiment of the present invention.

In the second embodiment of the present invention, an organizing agent comprising an organic polyonium compound is employed as the organizing agent. Here, the organic polyonium compound refers to a compound having organic chains and a plurality of onium ion atoms in a molecule. Such a compound usually forms a salt with a counterion. The molecular structure of organic polyonium compound used in the present invention is not restricted in particular; and molecular structures such as linear-chain structure, branched structure, and ring-shaped structure, for example, can be employed.

Examples of the organic polyonium compound include organic polyammonium compounds, organic polyphosphonium compounds, organic polypyridinium compounds, and organic polysulfonium compounds; among which the organic polyammonium compounds and organic polyphosphonium compounds are more preferably used since the reactivity of their resulting organic polyonium ions is favorable.

In the second embodiment of the present invention, the organic polyonium compound is preferably a compound comprising at least two onium ion atoms, an intramolecular organic chain having 1 to 4 carbons connecting the onium ion atoms to each other, and terminal organic chains having 1 to 24 carbons connected to the onium ion atoms, at least one of the terminal organic chains being an organic chain having 6 to 24 carbons.

Here, the onium ion atom in the organic polyonium compound refers to, for example, N⁺ atom in organic polyammonium compounds, P⁺ atom in organic polyphosphonium compounds, N⁺ atom in organic polypyridinium compounds, and S⁺ atom in organic polysulfonium compounds. The intramolecular organic chain having 1 to 4 carbons connecting the onium ion atoms to each other refers to a divalent organic chain, connected to the onium ion atoms mentioned above, having 1 to 4 carbons. The intramolecular organic chain may be shaped like a linear chain or ring and may have a branch or substituent. Examples of unsubstituted linear chains include methylene group, ethylene group, propylene group, and butylene group. The terminal organic chain having 1 to 24 carbons connected to the onium ion atom refers to a monovalent organic chain, connected to only one onium ion atom, having 1 to 24 carbons. The terminal organic chain may be shaped like a linear chain or ring and may have a branch or substituent. Examples of unsubstituted linear chains include methyl group, ethyl group, octyl group, decyl group, dodecyl group, hexadecyl group, and octadecyl group.

Among such organic polyonium compounds, linear-chain organic triammonium compounds and linear-chain organic triphosphonium compounds can be represented, for example, by the following general formula (1):

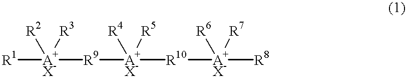

wherein A⁺ is an ion selected from the group consisting of nitrogen ion and phosphorus ion; R¹, R², R³, R⁴, R⁵, R⁶, R⁷, and R⁸ may be the same or different and each represents a member selected from the group consisting of a monovalent organic chain having 1 to 24 carbons and hydrogen atom, with the proviso that at least one of R¹, R², R³, R⁴, R⁵, R⁶, R⁷, and R⁸ must be a monovalent organic chain having 6 to 24 carbons; R⁹ and R¹⁰ may be the same or different and each represents a divalent organic chain having 1 to 4 carbons; and X⁻ represents an anion.

In the above-mentioned general formula (1), R⁹ and R¹⁰ are intramolecular organic chains, whereas R¹ to R⁸ are terminal organic chains. The organic chains of R¹ to R⁸ may be shaped like a linear chain or ring and may have a branch or substituent. Examples of substituent include carboxyl group, hydroxyl group, thiol group, and nitrile group. Preferably, the organic chains of R¹ to R¹⁰ are shaped like linear chains in the present invention. Examples of X⁻ include halogen anions such as chlorine ion, bromine ion, and iodine ion.

Preferably used as the organic polyonium compound in the second embodiment of the present invention is a linear-chain diammonium compound represented by the following general formula (2):

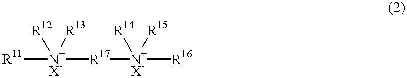

wherein R¹¹, R¹², R¹³, R¹⁴, R¹⁵, and R¹⁶ may be the same or different and each represents a member selected from the group consisting of a monovalent organic chain having 1 to 24 carbons and hydrogen atom, with the proviso that at least one of R¹¹, R¹², R¹³, R¹⁴, R¹⁵, and R¹⁶ must be a monovalent organic chain having 6 to 24 carbons; R¹⁷ represents a divalent organic chain having 1 to 4 carbons; and X⁻ represents an anion.

In the above-mentioned general expression (2), R¹⁷ is the intramolecular organic chain, whereas R¹¹ to R¹⁶ are terminal organic chains. The organic chains of R¹¹ to R¹⁷ may be shaped like a linear chain or ring and may have a branch or substituent. Examples of substituent include carboxyl group, hydroxyl group, thiol group, and nitrile group. Preferably, the organic chains of R¹¹ to R¹⁷ are shaped like linear chains in the present invention. Examples of X⁻ include halogen anions such as chlorine ion, bromine ion, and iodine ion.

As the organic polyonium compound in the second embodiment of the present invention, it is particularly preferable to use dimethyl octadecyl (trimethyl ammonium) propyl ammonium dibromide represented by the following chemical formula (3):

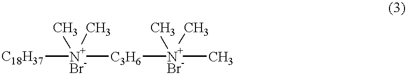

In the present invention, the organic polyonium compound is preferably an organic polyonium compound having a number average molecular weight of 1,000 or less. More preferably, the number average molecular weight is 50 to 800. If the number average molecular weight of organic polyonium compound exceeds 1,000, then the compatibility of organized layered clay mineral with the polymer tends to deteriorate, thereby making it harder for the layered clay mineral to finely disperse. Here, the number average molecular weight of organic polyonium compound refers to the number average molecular weight of the organic polyonium ion (organic polyonium ion including no counterion) occurring from the organic polyonium compound.

In the second embodiment of the present invention, the content of the organic polyonium compound is preferably 5% to 25% by weight based on the organized layered clay mineral. When a layered clay mineral is organized by an organic polyonium compound, the onium ion atom in the organic polyonium ion molecule combines with the surface of each layer of the layered clay mineral, whereas the terminal organic chain portion rises at a certain angle with respect to the layer of layered clay mineral without combining with the layer surface and is oriented in the interlayer direction. The case where the content of organic polyonium compound is less than 5% by weight indicates that the concentration of organic polyonium ion existing between layers of the layered clay mineral is low, so that the terminal organic chain portion rises at a smaller angle with respect to the layered clay mineral layer, whereby the effect of enhancing the interlayer distance of layered clay mineral caused by organization tends to decrease, thus deteriorating the dispersibility. If the content of organic polyonium compound exceeds 25% by weight, then the organization of layered clay mineral tends to progress too much, whereby the dispersibility with respect to polar polymers tends to decrease.

In the second embodiment of the present invention, the number of onium ion atoms in the organic polyonium compound is preferably 2 to 5. If the number of onium ion atoms exceeds 5, then one molecule of organic polyonium compound may combine with two or more layers of the layered clay mineral. In this case, since two or more layers are constrained by one molecule of organic polyonium compound, the effect of enhancing the interlayer distance of layered clay mineral caused by organization tends to decrease, thus deteriorating the dispersibility.

The organizing agent used in the second embodiment of the present invention may further comprise an organic monoonium compound in addition to the organic polyonium compound. In the case where the organizing agent comprises an organic polyonium compound and an organic monoonium compound, it becomes easier to control the polarity of layered clay mineral. An example of organic monoonium compound is an organic monoammonium salt; whereas preferred as the organic monoammonium salt are octadecyl ammonium salts, hexadecyl ammonium salts, dodecyl ammonium salts, decyl ammonium salts, octyl ammonium salts, and hexyl ammonium salts. In the case where the organizing agent comprises an organic monoonium compound in addition to an organic polyonium compound, the weight of organic polyonium compound in their total weight is preferably 50% by weight or greater.

The organization of layered clay mineral in the second embodiment can be carried out by the method disclosed in Japanese Patent No. 2627194 assigned to the present applicant, for example. Namely, it can be achieved by ion exchange of inorganic ions such as sodium ion in the layered clay mineral with organic polyonium ions occurring from the organic polyonium compound (e.g., organic polyammonium ion in the case of an organic polyammonium compound).

In the case where an organic polyammonium compound is used as the organic polyonium compound, organization can be carried out by the following method, for example. Namely, in the case where the layered clay mineral is shaped like a mass, it is initially pulverized into powder with a ball mill or the like. Subsequently, this powder is dispersed into water by use of a mixer or the like, so as to yield an aqueous dispersion of layered clay mineral. Separately, an aqueous solution of organic polyammonium compound is prepared. This aqueous solution is added to and mixed with the aqueous dispersion of layered clay mineral, whereby the inorganic cation in layered clay mineral is exchanged with the organic polyammonium ion generated from the organic polyammonium compound. Then, water is eliminated from this mixture, whereby an organized layered clay mineral can be obtained. As the dispersion medium for the organic polyammonium compound and layered clay mineral, not only water but also methanol, ethanol, propanol, isopropanol, and ethylene glycol, their mixtures, mixtures of these and water, and the like can be used.

According to a technique such as the one mentioned above, the layered clay mineral is organized by the organic polyonium compound. Since the metal ions existing between layers of the layered clay mineral, such as sodium ion, are exchanged with the organic polyonium ion generated from the organic polyonium compound, the organic polyonium ion intercalates between layers of the layered clay mineral.

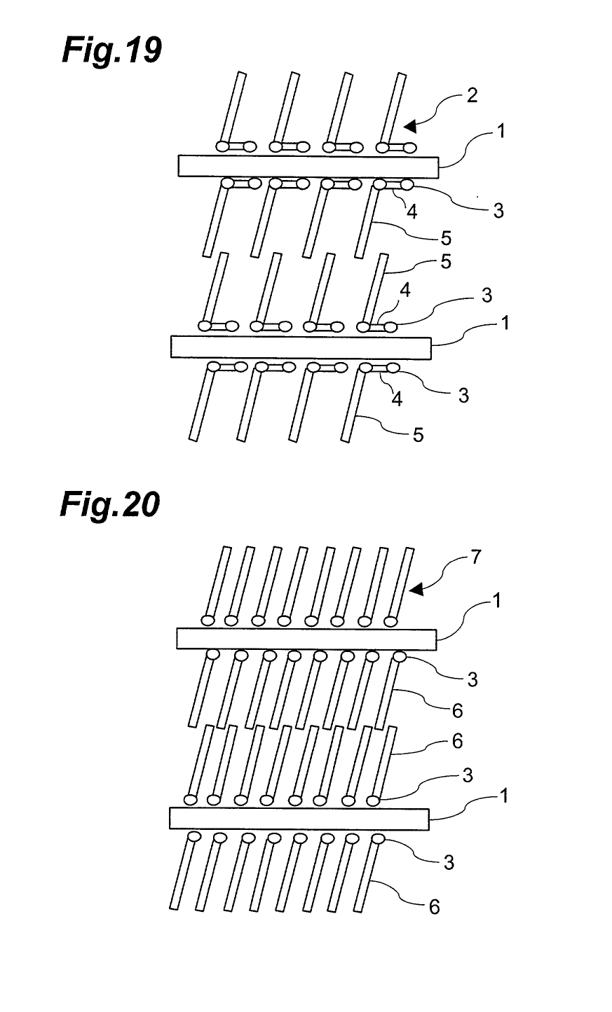

FIG. 19 is a view schematically showing a layered clay mineral organized by an organic polyonium compound. As shown in FIG. 19, an organic polyonium ion 2 having an onium ion atom 3, an intramolecular organic chain 4, and a terminal organic chain 5 combines with a surface of a single layer of layered clay mineral 1, whereby the layered clay mineral is organized. Here, it is the onium ion atom 3 in the organic polyonium ion 2 that combines with the single layer of layered clay mineral 1, whereas the terminal organic chain 5 rises at a certain angle with respect to the single layer of layered clay mineral 1 and is oriented in the interlayer direction. As a consequence, the interlayer distance of layered clay mineral increases.

FIG. 20 is a view schematically showing a layered clay mineral of the above-mentioned prior art organized by an organic monoonium compound alone. As shown in FIG. 20, an organic monoonium ion 7 comprising an onium ion atom 3 and an organic chain 6 combines with a single layer of layered clay mineral 1, whereby the layered clay mineral is organized. It is also the onium ion atom 3 in the organic monoonium ion 7 that combines with the single layer of layered clay mineral 1 in this case, whereby the organic chain 6 rises at a certain angle with respect to the single layer of layered clay mineral 1 and is oriented in the interlayer direction. Therefore, the interlayer distance of layered clay mineral increases.

Since the total number of onium ion atoms 3 shown in FIG. 19 and the total number of onium ion atoms 3 shown in FIG. 20 are identical to each other, the ion exchange capacity of layered clay mineral in FIG. 19 is the same as that in FIG. 20. However, the number of organic chains existing between layers is overwhelmingly greater in FIG. 20 which is based on the above-mentioned prior art method, whereby it is seen that the hydrophobic property is improved very much in the layered clay mineral shown in FIG. 20. Since the improvement in hydrophobic property causes the polarity to decrease, the difference between the polarities of layered clay mineral and polar polymer increases when the polar polymer is used as a polymer to which the layered clay mineral is added, whereby the dispersibility cannot be improved.

In the layered clay mineral organized by an organic polyonium compound, shown in FIG. 19 and employed in the present invention, by contrast, the amount of organic compound introduced therein is small, whereby the improvement in hydrophobic property (decrease in polarity) is suppressed. Therefore, the layered clay mineral can finely be dispersed in various kinds of polymers. In particular, fine dispersion in polar polymers, which has been difficult in the above-mentioned prior art, can be achieved.

The polymer composite of the present invention comprises a layered clay mineral organized by the above-mentioned organizing agent and a polymer. The polymer employed in the present invention is not restricted in particular in any of the first and second embodiments of the present invention. For example, those having various chemical structures, molecular structures (linear-chained, branched, cross-linked, etc), polarities (polar and nonpolar), crystallinities, moduli of elasticity (resin-like, rubber-like, etc), molecular weights, and the like can be used alone or as a mixture.

Examples of such a polymer include a polymer made of hydrocarbons alone, a polymer having a polar group in a side chain thereof, a polymer having a polar bond in a main chain thereof, and a combination of these polymers. The polymer having a polar group in a side chain thereof and the polymer having a polar bond in a main chain thereof are polar polymers in general.

Examples of polymer made of hydrocarbons alone include polyolefins such as polyethylene, polypropylene, ethylene propylene copolymer, ethylene α-olefin copolymer and polymethyl pentene; polydienes such as polybutadiene and polyisoprene; polystyrene; and styrene block copolymers such as styrene-butadiene copolymer, hydrogenated styrene-butadiene copolymer, styrene-butylene-styrene block copolymer, hydrogenated styrene-butylene-styrene block copolymer, and styrene-isoprene-styrene block copolymer. Also usable are so-called denatured polymers in which the above-mentioned polymers are modified with a polar group such as maleic anhydride group.

It is sufficient for the polymer having a polar group in a side chain thereof to comprise at least one kind of polar group in the side chain. Examples thereof include polymers having a nitrile group in their side chains, such as acrylonitrile-styrene copolymer, acrylonitrile-butadiene-styrene copolymer, acrylonitrile-butadiene copolymer, hydrogenated acrylonitrile-butadiene copolymer, and acrylonitrile-(meth)acrylate copolymer; compounds having a hydroxyl group in their side chains, such as polyvinyl alcohol, ethylene-vinyl alcohol copolymer, partial saponification products of polyvinyl acetate, partial saponification products of ethylene-polyvinyl acetate, and phenol resin; polymers having an amide group in their side chains, such as polyacrylamide; polymers having an ester group in their side chains, such as poly(meth)acrylate copolymer, ethylene-(meth)acrylate copolymer, polyvinyl acetate, and ethylene-vinyl acetate copolymer; polymers having an ether group in their side chains, such as polyvinyl ether; polymers having a carboxyl group in their side chains, such as styrene-maleic anhydride copolymer, acrylic acid-(meth)acrylate copolymer, and ethylene-acrylic acid copolymer; and polymers containing halogen atoms, such as chlorinated polypropylene, polyvinyl chloride, polyvinylidene chloride, and polytetrafluoroethylene. Here, (meth)acrylate copolymer refers to methacrylate copolymer or acrylate copolymer.

The polymer having a polar bond in its main chain may be any polymer having at least one kind of polar bond in its main chain. Examples thereof include polymers having an amide bond in their main chains (polyamides), such as polyhexamethylene adipamide (6,6-nylon) and polyphthalamide; polymers having an imide bond in their main chains (polyimides), such as polypyromellitimide; polymers having an ester bond in their main chains (polyesters), such as polyethylene terephthalate, polybutylene terephthalate, and polyarylate; polymers having an ether bond in their main chains (polyethers), such as polyphenylene oxide, polyacetal, and polyether nitrile; polymers having a sulfide bond in their main chains, such as poly(phenylene sulfide); polymers having an imidazole bond in their main chains, such as polybenzimidazole; polymers having a sulfone group in their main chains, such as poly(arylene sulfone); polymers having a siloxane bond in their main chain, such as polydimethyl siloxane; polymers having a carbonate bond in their main chain (polycarbonates); polymers having a urethane bond in their main chains (polyurethanes); and polymers having a urea bond in their main chains (polyureas).

Examples of those having two or more kinds of polar bonds in their main chains include polyamide imide, polyether sulfone, polyether ketone, polyether imide, polyether type polyurethane, polyester type polyurethane, and ether type polyester.

Further, cross-linked products and vulcanized products of the above-mentioned polymers and the like are usable. Examples thereof include rubber-like polymers such as butadiene rubber, chloroprene rubber, nitrile rubber, epichlorohydrin rubber, isoprene rubber, butyl rubber, ethylene-propylene rubber, styrene-butadiene rubber, EPDM (ethylene-propylene-diene terpolymer), acryl rubber, acrylonitrile-butadiene rubber, and natural rubber.

In the present invention, it is preferred that, among the above-mentioned polymers, polar polymers such as polymers having a polar group in their side chains and polymers having a polar bond in their main chains be used. As the polar polymer, polymers having a solubility parameter of 9 (cal/cm³)^{½} (18.4 (MJ/m³)^{½}) or greater are preferable, and those having a solubility parameter of 9 to 20 (cal/cm³)^{½} are more preferable. The solubility parameter is further preferably 9 to 14 (cal/cm³)^{½}, 9 to 13 (cal/cm³)^{½} in particular. The solubility parameter is furthermore preferably 9 to 12 (cal/cm³)^{½}, most preferably 9 to 10 (cal/cm³)^{½}.

In the present invention, the solubility parameter of polymer is a parameter indicating the polarity of polymer, and is defined by the value calculated on the basis of “Calculation of Solubility Parameter,” Coating Jiho, No. 193, pp. 9-11 (1993).

The solubility parameter may be determined by a method based on measurement or calculation. Examples of the method based on measurement include vaporization latent heat method, vapor pressure method, dissolution method, swelling method, surface tension method, critical pressure method, thermal swelling coefficient method, and calculating method based on refractive index. The vaporization latent heat method and vapor pressure method are useful for low-molecular compounds having a vapor pressure, whereas the dissolution method and swelling method are useful for polymers.

On the other hand, the method of determining the solubility parameter δ according to calculation includes one in which, while the molecular cohesive energy ΔE (cal/mol) and molar volume (ml/mol) are defined for each functional group constituting the compound, the parameter is determined from the following expression (I):

δ=(ΔE/V)^{½} (I)

This method is convenient for determining the solubility parameter of compounds having no vapor pressure.

For this method, there are the constants proposed by Small, Hoy, Rheineck et al., and Tortorello et al. These involve a method in which, while the molecular attraction constant G, which is the product of cohesive energy and molar volume, is defined, the parameter is calculated according to the following expression (II) by use of the density d and molecular weight M of the compound to be determined:

δ=ΣG/V=d(ΣG)/M (II)

This method, however, is disadvantageous in that calculation cannot be effected unless the density and molecular weight are known.

The method proposed by Fedors, by contrast, is a method in which the cohesive energy Δe₁ (cal/mol) and molar volume Δv₁ (cc/mol/25° C.) are defined for each unit functional group, and the parameter is determined from their sums according to the following expression (III):

δ=[Σ(Δe₁)/Σ(Δv₁)]^{½} (III)

This method enables calculation even when the density is unknown, whereby it is a useful method when designing polymers, and the like.

Therefore, the above-mentioned method proposed by Fedors is used for determining the solubility parameter of polymer in the present invention. While the following Table 1 shows examples of the above-mentioned Δe₁ and Δv₁, reference can be made to the above-mentioned Coating Jiho or R. F. Fedors, Polym. Eng. Sci., 14, 147 (1974) for the evaporation energy Δe₁ and molar volume Δv₁.

TABLE 1

| | Evaporation | Molar Volume | Structural Unit |
|---|---|---|---|
| Functional | Energy Δe₁ | Δv₁ | Solubility Parameter |
| Group | (cal/mol) | (cc/mol/25° C.) | (cal/cc/25° C.) |
| —CH₃ | 1125 | 33.5 | 5.79 |
| —CH₂ | 1180 | 16.1 | 8.56 |
| >CH— | 820 | −1.0 | — |
| >C< | 350 | −19.2 | — |
| CH₂═ | 1030 | 28.5 | 6.01 |
| —CH═ | 1030 | 13.5 | 8.73 |
| >C═ | 1030 | −5.5 | — |
| CN | 6100 | 24.0 | 15.94 |

Examples of the polymer having a solubility parameter of 9 (cal/cm³)^{½} (18.4 (MJ/m³)^{½}) or greater include polymers having a nitrile group and/or hydroxyl group.

Among the above-mentioned polymers, those having a nitrile group and/or hydroxyl group are preferably used in the present invention. This is because of the fact that the polymers having a nitrile group and/or hydroxyl group are particularly excellent in affinity with layered clay minerals organized with organizing agents, and are also excellent in properties of their resulting polymer composites such as mechanical properties and gas barrier property.

As the polymer having a nitrite group, acrylonitrile-butadiene copolymer and hydrogenated acrylonitrile-butadiene copolymer are preferably used in particular since they are particularly excellent in the mechanical strength and gas barrier property of the resulting polymer composites.

The nitrile group content in the polymer having a nitrile group is preferably 5% to 75% by weight, more preferably 10% to 50% by weight. The gas barrier property of the resulting polymer composite tends to be insufficient if the nitrile group content is less than 5% by weight, whereas the polymer tends to raise its viscosity if the nitrile group content exceeds 75% by weight, whereby stirring for a long period of time and a high shearing force may be necessary for dispersing the layered clay mineral.

As the polymer having a hydroxyl group, ethylene-vinyl alcohol copolymer is preferable in particular since it is particularly excellent in the strength and gas barrier property of the resulting polymer composite. The hydroxyl group content in the polymer having a hydroxyl group is preferably 20% to 90% by weight, more preferably 30% to 80% by weight. The gas barrier property of the resulting polymer composite tends to be insufficient if the hydroxyl group content is less than 20% by weight, whereas the hygroscopic property of the resulting polymer composite tends to be too high if the hydroxyl group content exceeds 90% by weight.

The molecular weight of the polymer employed in the present invention is preferably 5,000 to 10,000,000 interms of number average molecular weight. The physical properties of the resulting polymer composite such as mechanical properties tend to deteriorate if the number average molecular weight is less than 5,000, whereas the layered clay mineral tends to be harder to disperse if the number average molecular weight exceeds 10,000,000.

The method of mixing the above-mentioned polymer and organized layered clay mineral is not restricted in particular in any of the first and second embodiments of the present invention. For example, the mixture may be obtained by a method comprising the steps of dispersing or dissolving the polymer and the organized layered clay mineral into a solvent such as water or an organic solvent, and then removing the solvent.

Alternatively, the mixture can be obtained when the polymer and the organized layered clay mineral are heated to the melting point or softening point of the polymer or higher and mixed. At the time of heating, it is preferred that the organized layered clay mineral be uniformly dispersed with a shearing force applied thereto. As means for applying a shearing force while heating, an extruder is preferably used. Here, organic solvents, oils, and the like can be added thereto; and the crosslinking and/or vulcanization of the polymer may be carried out after or during the dispersion of layered clay mineral.

For example, in addition to the above-mentioned methods, the polymer composite can be obtained by a method comprising the steps of adding the organized layered clay mineral to a monomer and polymerizing the monomer in the presence of the organized layered clay mineral. Also, when the polymer is generated upon mixing and reacting at least two components with each other, as in the case of polyurethane, polyester, polyurea, epoxy resin, and the like, the polymer composite can be obtained if the organized layered clay mineral is added to at least one of at least two components before the reaction.

In each of the first and second embodiments of the present invention, the mixing ratio between the polymer and organized layered clay mineral is such that, with respect to 100 parts by weight of the former, the latter is preferably 0.01 to 200 parts by weight, more preferably 0.1 to 100 parts by weight, particularly preferably 0.1 to 30 parts by weight. The physical properties of the resulting polymer composite such as mechanical properties tend to be insufficient if the layered clay mineral is less than 0.01 part by weight, whereas the polymer tends to be incapable of forming a continuous layer if the layered clay mineral exceeds 200 parts by weight, whereby there is a tendency that mechanical properties of the polymer composite deteriorate, and its viscosity increases, thus losing the processibility thereof.

In the present invention, pigments, heat stabilizers, flame retardants, antioxidants, additives for weatherability improving agent, releasing agents, plasticizers, reinforcing agents, and the like can be added as long as properties of the polymer composite are not greatly deteriorated thereby.

In the first embodiment of the present invention, the organized layered clay mineral dispersed in the polymer preferably has an average particle size of 0.05 to 5 μm, more preferably 0.05 to 1 μm. If the average particle size of organized clay mineral exceeds 5 μm, then physical properties of the resulting polymer composite such as mechanical properties tend to be insufficient.

While the interlayer distance of layered clay mineral increases in the present invention since the intercalation (intercalation) of polymer between layers of the layered clay mineral is possible, the interlayer distance at this time is preferably wider than that before the intercalation by at least 10 angstroms, more preferably 30 angstroms in each of the first and second embodiments of the present invention. Further preferably, the interlayer distance is widened by at least 100 angstroms. Most preferably, the interlayer distance is widened to such an extent that the layer structure of layered clay mineral disappears.

The interlayer distance can be measured by X-ray diffraction. The fact that the interlayer distance is enhanced can be seen by peaks occurring in a smaller diffraction angle region in a X-ray diffraction pattern. The fact that the regularity of a layer structure is lost can be seen from peaks becoming unclear or disappearing. Also, the state of dispersion of layered clay mineral can be seen indirectly from the viscosity thereof. Namely, while a polymer composite in which a layered clay mineral is finely dispersed greatly raises its viscosity (melt viscosity or the like) as compared with the polymer containing no layered clay mineral, the viscosity rises only a little in a polymer composite in which the state of dispersion of layered clay mineral is unfavorable.

Since the first embodiment of the present invention uses a layered clay mineral whose polarity is made closer to that of polymers upon organizing 25% to 85% of total ion exchange capacity of layered clay mineral with an organizing agent, as explained in the foregoing, the layered clay mineral disperses finely into various kinds of polymers including polar polymers. The fact that the dispersion of layered clay mineral is fine means that the contact area between the layered clay mineral and polymer increases, so that the ratio by which the polymer is constrained by the layered clay mineral increases, whereby mechanical properties, such as strength at break, of thus obtained polymer composite improve, and its gas barrier property also becomes excellent. Therefore, the polymer composite of the present invention is usable in fields where high mechanical properties are required, and in fields where the gas barrier property is required. Also, when polymers comprising a nitrile group, such as acrylonitrile-butadiene copolymer and hydrogenated acrylonitrile-butadiene copolymer, or polymers comprising a hydroxyl group, such as ethylene-vinyl alcohol copolymer, are employed as the polymer, the present invention is usable in fields where the gas barrier property is considered particularly important, such as coating materials and packaging materials, since these polymers are excellent in mechanical properties and gas barrier property in particular.

In the second embodiment of the present invention, since the layered clay mineral is organized by use of an organizing agent comprising an organic polyonium compound as the organizing agent, one molecule of organizing agent enables the ion exchange of a plurality of metal ions existing between layers of the layered clay mineral. Therefore, the amount of use of organizing agent decreases, so that the organized layered clay mineral is restrained from improving its hydrophobic property, whereby its dispersibility with respect to various kinds of polymers improves. In particular, it enables the fine dispersion into polar polymers, which has been difficult with the prior art.

Since properties such as rigidity and gas barrier property improve in the polymer in which the layered clay mineral is finely dispersed, the polymer composite of the present invention is favorably usable in fields where such properties are demanded. Also, in the present invention, metal ions in the layered clay mineral can be eliminated upon ion exchange with a relatively small amount of organizing agent, whereas the ion-exchanged layered clay mineral is excellent in the dispersibility with respect to various kinds of polymers, whereby it is possible to obtain a polymer composite excellent in various physical properties, in which the amount of residual metal ions is small. Such a polymer composite is favorably usable in particular in electrical and electronic fields and the like where the remnant of impurity metal ions becomes problematic.

### EXAMPLES

In the following, preferred examples of the present invention will be explained in further detail, which will not restrict the present invention.

### Example 1

Into 5,000 ml of water at 80° C., 80 g of sodium montmorillonite (layered clay mineral manufactured by Kunimine Industries Co., Ltd.; product name: Kunipia F; total cation exchange capacity: 119 meq/100 g) were dispersed. Into 2,000 ml of water at 80° C., 7 g of dodecyl amine and 7 ml of concentrated hydrochloric acid were dissolved, and the resulting solution was added to the montmorillonite dispersion obtained above, whereby a precipitate was obtained. This precipitate was filtered out, washed three times with water at 80° C., and freeze-dried, whereby organized montmorillonite in which 70% of total cation exchange capacity was organized by dodecyl ammonium was obtained.

This organized montmorillonite and acrylonitrile-butadiene copolymer having an acrylonitrile content of 27% (Nipol DN302 manufactured by Nippon Zeon Co., Ltd.) were mixed at 80° C. by use of a mill, whereby a polymer composite was obtained. The mixing ratio between acrylonitrile-butadiene copolymer and organized montmorillonite was such that the latter was 20 parts by weight with respect to 100 parts by weight of the former.

### Example 2

In conformity to the method described in Example 1, organized montmorillonite in which 50% of total cation exchange capacity was organized by dodecyl ammonium was obtained. A polymer composite was obtained in the same manner as Example 1 except that this organized montmorillonite was used in place of organized montmorillonite in which 70% of total cation exchange capacity was organized by dodecyl ammonium.

### Comparative Example 1

In conformity to the method described in Example 1, organized montmorillonite in which 90% of total cation exchange capacity was organized by dodecyl ammonium was obtained. A polymer composite was obtained in the same manner as Example 1 except that this organized montmorillonite was used in place of organized montmorillonite in which 70% of total cation exchange capacity was organized by dodecyl ammonium.

### Comparative Example 2

In conformity to the method described in Example 1, organized montmorillonite in which 20% of total cation exchange capacity was organized by dodecyl ammonium was obtained. A polymer composite was obtained in the same manner as Example 1 except that this organized montmorillonite was used in place of organized montmorillonite in which 70% of total cation exchange capacity was organized by dodecyl ammonium.

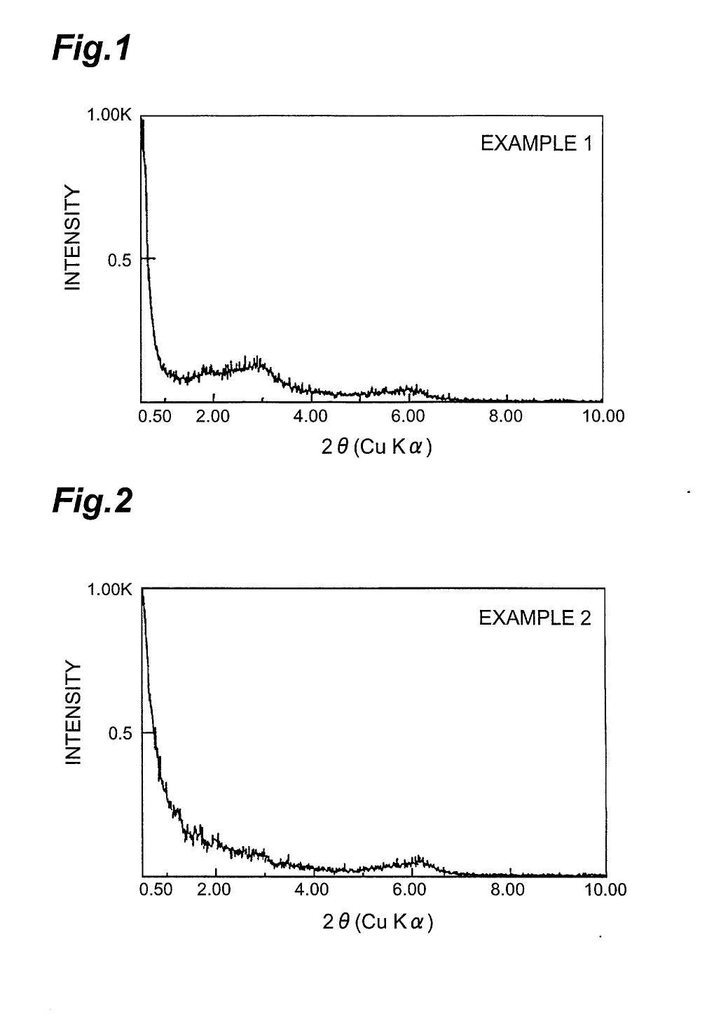

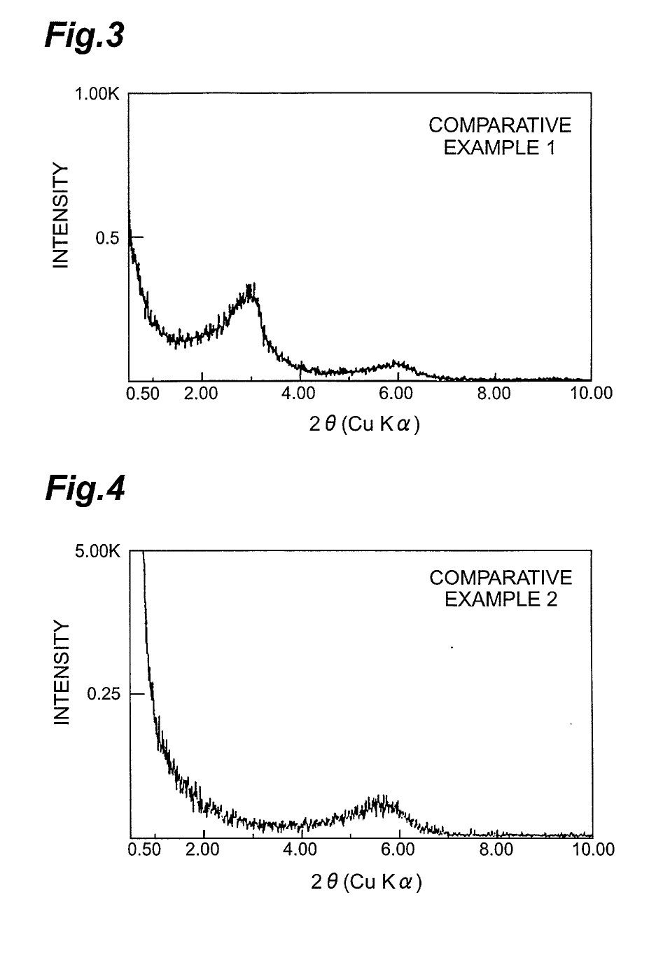

X-ray diffraction was carried out with the polymer composites obtained in Examples 1 and 2 and Comparative Examples 1 and 2. Thus obtained X-ray diffraction patterns are shown in FIGS. 1 to 4. As a result, clear peaks were seen in Comparative Examples 1 and 2. By contrast, the peak in Example 1 was broad, whereas no clear peak was observed in Example 2.

Subsequently, the melt viscosity of thus obtained polymer composite at 80° C. and the melt viscosity of a polymer having no organized montmorillonite added thereto were measured, and the viscosity ratio (the value obtained when the former is divided by the latter) was calculated, so that the increase in viscosity was evaluated. The results are collectively shown in Table 2. The results of total evaluation of dispersibility based on the viscosity ratio and X-ray diffraction results and the ratio (%) of organization of montmorillonite are also shown in Table 2.

TABLE 2

| | Example | Example | Comparative | Comparative |
|---|---|---|---|---|
| | 1 | 2 | Example 1 | Example 2 |
| Organizing | 70 | 50 | 90 | 20 |
| Ratio (%) | | | | |
| Viscosity | 3 or | 3 or | 3 or | 3 or |
| Ratio | more | more | less | less |
| Total Evaluation | ◯ | ⊚ | X | X |
| of Dispersibility | | | | |

⊚: Dispersion is quite excellent.
◯: Dispersion is excellent.
X: Dispersion is not favorable.

### Example 3

Into 5,000 ml of water at 80° C., 80 g of sodium montmorillonite (layered clay mineral manufactured by Kunimine Industries Co., Ltd.; product name: Kunipia F; total cation exchange capacity: 119 meq/100 g) were dispersed. Into 2,000 ml of water at 80° C., 9 g of octadecyl amine and 7 ml of concentrated hydrochloric acid were dissolved, and the resulting solution was added to the montmorillonite dispersion obtained above, whereby a precipitate was obtained. This precipitate was filtered out, washed three times with water at 80° C., and freeze-dried, whereby organized montmorillonite in which 70% of total cation exchange capacity was organized by octadecyl ammonium was obtained.

This organized montmorillonite and acrylonitrile-butadiene copolymer having an acrylonitrile content of 18% (Nipol DN401 manufactured by Nippon Zeon Co., Ltd.) were mixed at 80° C. by use of a mill, whereby a polymer composite was obtained. The mixing ratio between acrylonitrile-butadiene copolymer and organized montmorillonite was such that the latter was 20 parts by weight with respect to 100 parts by weight of the former.

### Example 4

In conformity to the method described in Example 3, organized montmorillonite in which 50% of total cation exchange capacity was organized by octadecyl ammonium was obtained. A polymer composite was obtained in the same manner as Example 3 except that this organized montmorillonite was used in place of organized montmorillonite in which 70% of total cation exchange capacity was organized by octadecyl ammonium.

### Comparative Example 3

In conformity to the method described in Example 3, organized montmorillonite in which 90% of total cation exchange capacity was organized by octadecyl ammonium was obtained. A polymer composite was obtained in the same manner as Example 3 except that this organized montmorillonite was used in place of organized montmorillonite in which 70% of total cation exchange capacity was organized by octadecyl ammonium.

### Comparative Example 4

In conformity to the method described in Example 3, organized montmorillonite in which 20% of total cation exchange capacity was organized by octadecyl ammonium was obtained. A polymer composite was obtained in the same manner as Example 3 except that this organized montmorillonite was used in place of organized montmorillonite in which 70% of total cation exchange capacity was organized by octadecyl ammonium.

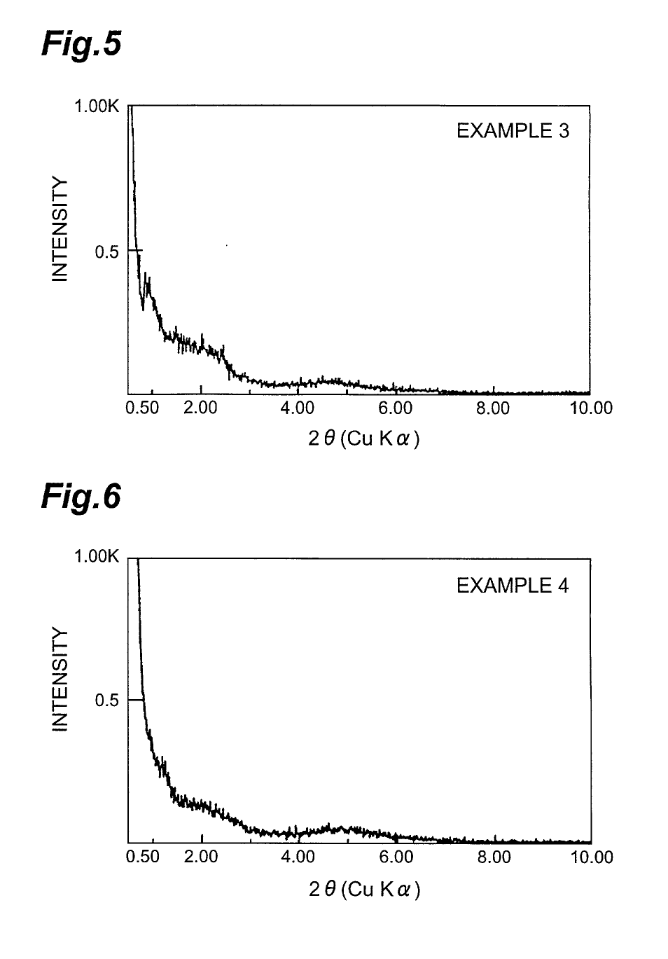

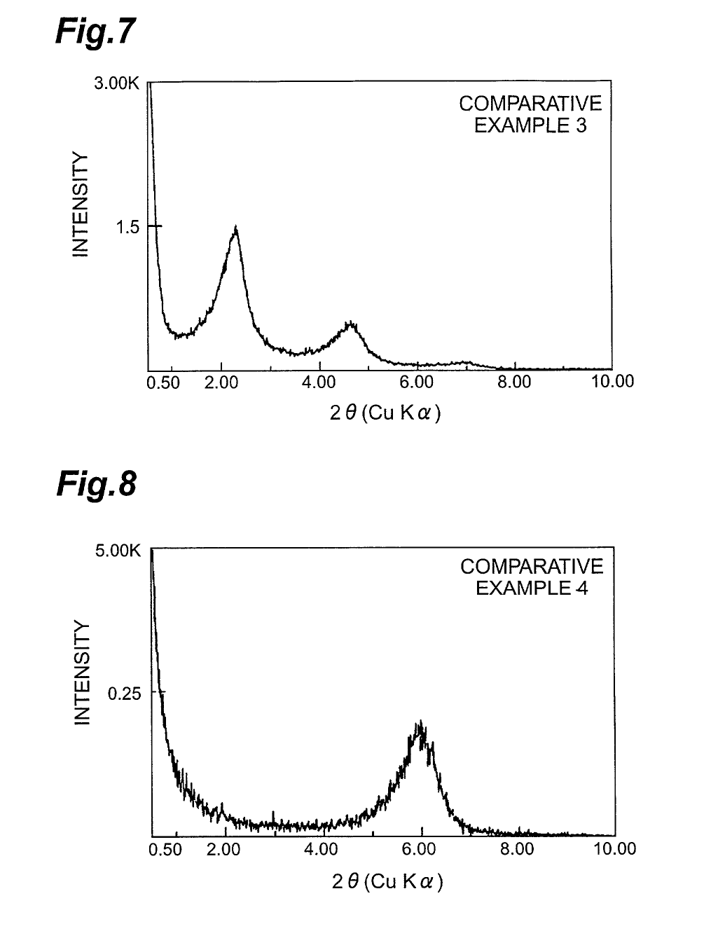

X-ray diffraction was carried out with the polymer composites obtained in Examples 3 and 4 and Comparative Examples 3 and 4. Thus obtained X-ray diffraction patterns are shown in FIGS. 5 to 8. As a result, while clear peaks were seen in Comparative Examples 3 and 4, no clear peaks were observed in Examples 3 and 4.

Subsequently, the viscosity ratio was evaluated in thus obtained polymer composites by a method similar to the evaluation method in Example 1. The results of evaluation are shown in Table 3. The results of total evaluation of dispersibility based on the viscosity ratio and X-ray diffraction results and the ratio (%) of organization of montmorillonite are also shown in Table 3.

TABLE 3

| | Example | Example | Comparative | Comparative |
|---|---|---|---|---|
| | 3 | 4 | Example 3 | Example 4 |
| Organizing | 70 | 50 | 90 | 20 |
| Ratio (%) | | | | |
| Viscosity | 3 or | 3 or | 3 or | 3 or |
| Ratio | more | more | less | less |
| Total Evaluation | ⊚ | ⊚ | X | X |
| of Dispersibility | | | | |

⊚: Dispersion is quite excellent.
◯: Dispersion is excellent.
X: Dispersion is not favorable.

### Example 5

A polymer composite was obtained in the same manner as Example 3 except that, as the acrylonitrile-butadiene copolymer, one having an acrylonitrile content of 27% (Nipol DN302 manufactured by Nippon Zeon Co., Ltd.) was used.

### Example 6

In conformity to the method described in Example 3, organized montmorillonite in which 50% of total cation exchange capacity was organized by octadecyl ammonium was obtained. A polymer composite was obtained in the same manner as Example 5 except that this organized montmorillonite was used in place of organized montmorillonite in which 70% of total cation exchange capacity was organized by octadecyl ammonium.

### Comparative Example 5

In conformity to the method described in Example 3, organized montmorillonite in which 90% of total cation exchange capacity was organized by octadecyl ammonium was obtained. A polymer composite was obtained in the same manner as Example 5 except that this organized montmorillonite was used in place of organized montmorillonite in which 70% of total cation exchange capacity was organized by octadecyl ammonium.

### Comparative Example 6

In conformity to the method described in Example 3, organized montmorillonite in which 20% of total cation exchange capacity was organized by octadecyl ammonium was obtained. A polymer composite was obtained in the same manner as Example 5 except that this organized montmorillonite was used in place of organized montmorillonite in which 70% of total cation exchange capacity was organized by octadecyl ammonium.

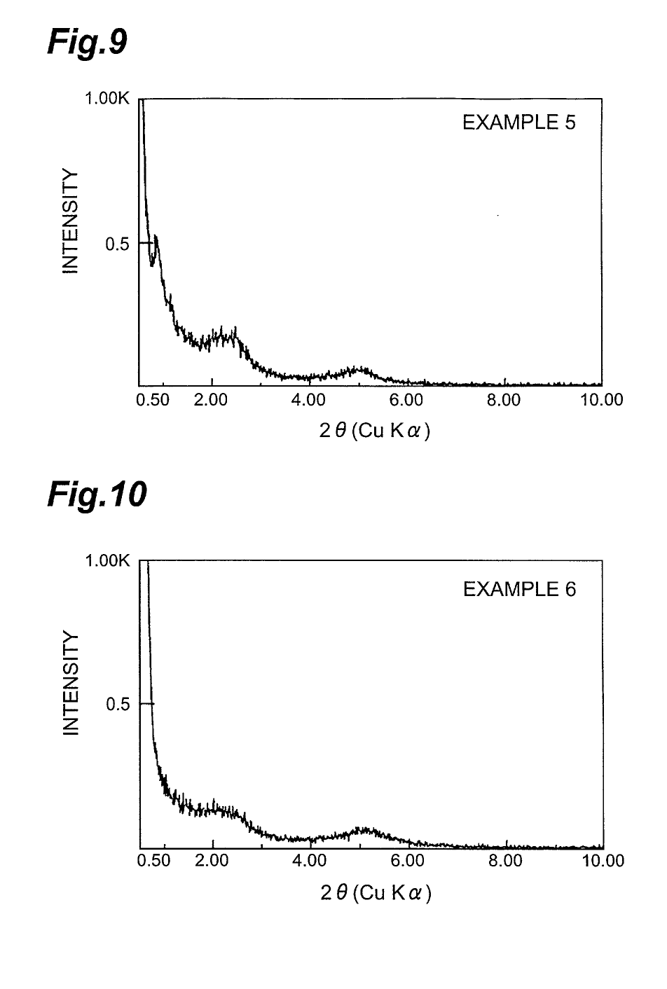

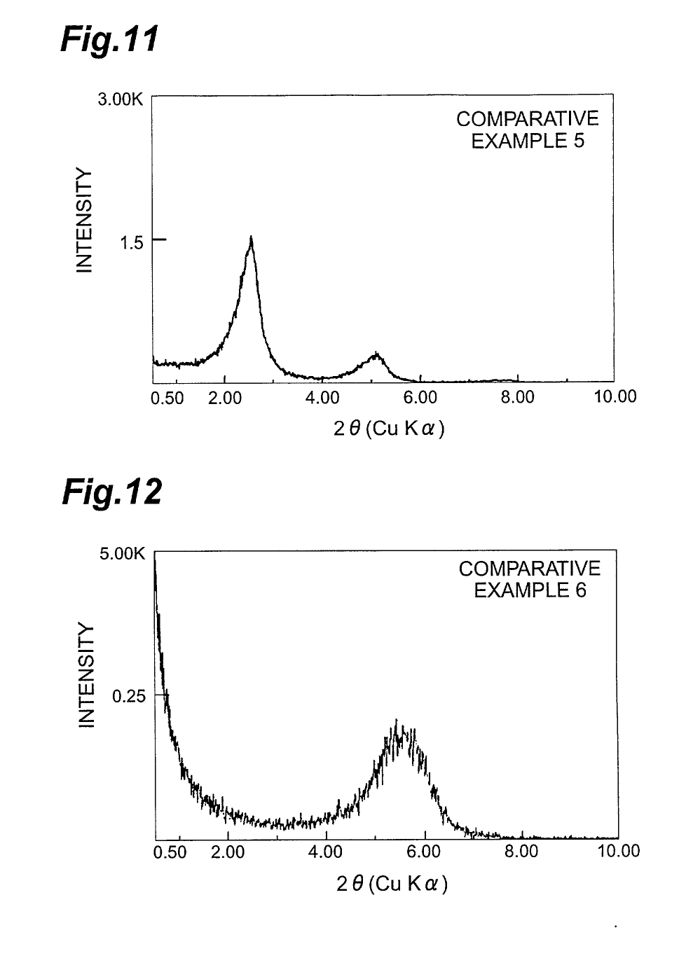

X-ray diffraction was carried out with the polymer composites obtained in Examples 5 and 6 and Comparative Examples 5 and 6. Thus obtained X-ray diffraction patterns are shown in FIGS. 9 to 12. As a result, while clear peaks were seen in Comparative Examples 5 and 6, peaks were broad in Examples 5 and 6.

Subsequently, the viscosity ratio was evaluated in thus obtained polymer composites by a method similar to the evaluation method in Example 1. The results of evaluation are shown in Table 4. The results of total evaluation of dispersibility based on the viscosity ratio and X-ray diffraction results and the ratio (%) of organization of montmorillonite are also shown in Table 4.

TABLE 4

| | Example | Example | Comparative | Comparative |
|---|---|---|---|---|
| | 5 | 6 | Example 5 | Example 6 |
| Organizing | 70 | 50 | 90 | 20 |
| Ratio (%) | | | | |
| Viscosity | 3 or | 3 or | 3 or | 3 or |
| Ratio | more | more | less | less |
| Total Evaluation | ◯ | ◯ | X | X |
| of Dispersibility | | | | |

⊚: Dispersion is quite excellent.
◯: Dispersion is excellent.
X: Dispersion is not favorable.

### Example 7

In conformity to the method described in Example 1, organized montmorillonite in which 70% of total cation exchange capacity was organized by dodecyl ammonium was obtained. Using a mill, 10 parts by weight of thus obtained organized montmorillonite and 100 parts by weight of acrylonitrile-butadiene copolymer having an acrylonitrile content of 34% (Nipol 1042 manufactured by Nippon Zeon Co., Ltd.) were kneaded at 80° C., whereby a polymer composite was obtained. To 100 parts by weight of this polymer composite, 5 parts by weight of zinc oxide, 1.5 parts by weight of sulfur, 1 part by weight of stearic acid, and 1 part by weight of vulcanization accelerator (tetramethyl thiuram disulfide) were added, and the resulting mixture was kneaded with a roll. Then, the mixture was heated with a press at 100° C. for 20 minutes, so as to be vulcanized, whereby a vulcanized molded product was obtained.

### Example 8

In conformity to the method described in Example 3, organized montmorillonite in which 70% of total cation exchange capacity was organized by octadecyl ammonium was obtained. A vulcanized molded product was obtained in the same manner as Example 7 except that this organized montmorillonite was used in place of organized montmorillonite in which 70% of total cation exchange capacity was organized by dodecyl ammonium.

### Comparative Example 7

In conformity to the method described in Example 1, organized montmorillonite in which 100% of total cation exchange capacity was organized by dodecyl ammonium was obtained. A vulcanized molded product was obtained in the same manner as Example 7 except that this organized montmorillonite was used in place of organized montmorillonite in which 70% of total cation exchange capacity was organized by dodecyl ammonium.

### Comparative Example 8

In conformity to the method described in Example 3, organized montmorillonite in which 100% of total cation exchange capacity was organized by octadecyl ammonium was obtained. A vulcanized molded product was obtained in the same manner as Example 7 except that this organized montmorillonite was used in place of organized montmorillonite in which 70% of total cation exchange capacity was organized by dodecyl ammonium.

### Comparative Example 9

A vulcanized molded product was obtained in the same manner as Example 7 except that no organized montmorillonite was used.

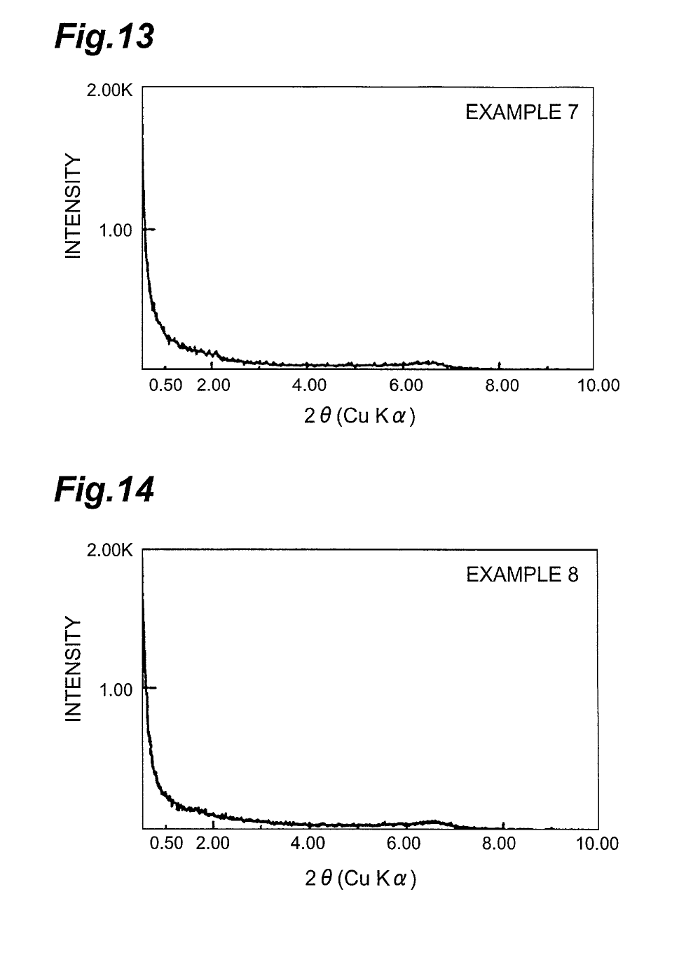

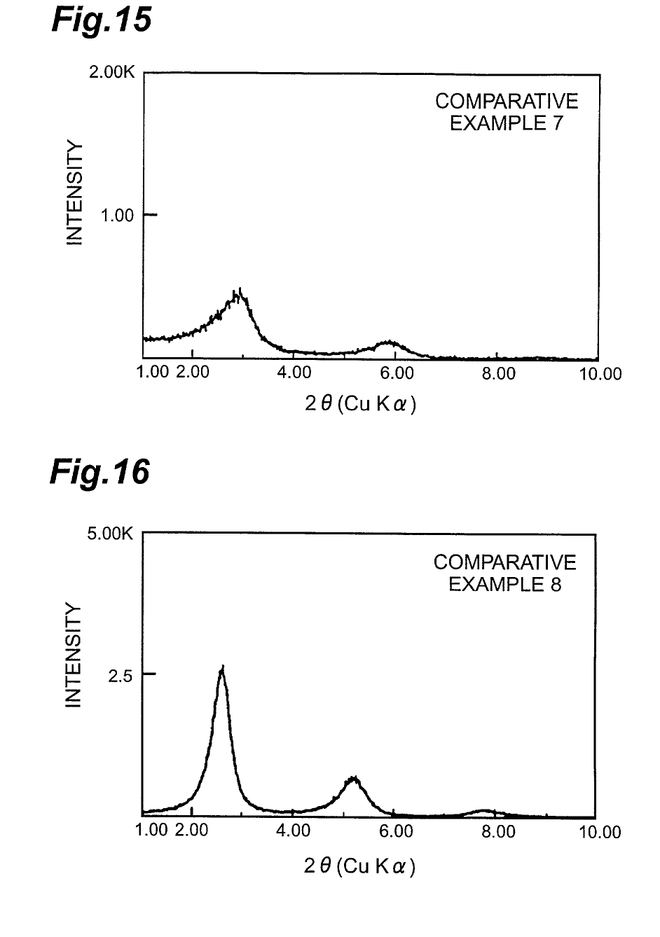

X-ray diffraction was carried out with the vulcanized molded products obtained in Examples 7 and 8 and Comparative Examples 7 and 8. Thus obtained X-ray diffraction patterns are shown in FIGS. 13 to 16. As a result, while clear peaks were seen in Comparative Examples 7 and 8, no clear peaks were observed in Examples 7 and 8. Also, the vulcanized molded products obtained in Examples 7 and 8 and Comparative Examples 7 to 9 were subjected to a tensile test in conformity to JIS K6301, so as to determine their breaking strength. Here, each specimen was shaped into the form of dumbbell No. 3. Thus obtained breaking strength is shown in Table 4. It was seen that, while the vulcanized molded products of Examples 7 and 8 each exhibited a high breaking strength exceeding 5 MPa, the vulcanized molded products of Comparative Examples 7 to 9 each exhibited a strength lower than 4 MPa.

Subsequently, the nitrogen gas permeability of the vulcanized molded products obtained in Examples 7 and 8 and Comparative Examples 7 to 9 were studied at 60° C. The nitrogen gas permeability test was carried out at a transmission area of 16.2 cm² and a film thickness of 0.5 mm by use of a gas/liquid permeability meter manufactured by Yanako Analysis Industry Co., Ltd. The results are shown in Table 5, which indicate that the polymer composites of Examples 7 and 8 exhibit a nitrogen gas permeability lower than that of Comparative Examples 7 to 9 by about 40%, thus yielding a higher gas barrier property.

Further, in a method similar to the evaluation method in Example 1, the viscosity ratio was evaluated in the vulcanized molded products obtained in Examples 7 and 8 and Comparative Examples 7 and 8. The results of evaluation are shown in Table 5. The results of total evaluation of dispersibility based on the viscosity ratio, breaking strength, and X-ray diffraction results and the ratio (%) of organization of montmorillonite are also shown in Table 5.

TABLE 5

| | | | Comparative | Comparative | Comparative |
|---|---|---|---|---|---|
| | Example 7 | Example 8 | Example 7 | Example 8 | Example 9 |
| Organizing | 70 | 70 | 100 | 100 | — |
| Ratio (%) | | | | | |
| Nitrogen Gas Permeability | 6.8 × 10⁻¹⁰ | 6.3 × 10⁻¹⁰ | 9.3 × 10⁻¹⁰ | 9.0 × 10⁻¹⁰ | 11.1 × 10⁻¹⁰ |
| Coefficient | | | | | |
| (cm³-cm/cm²-s-Pa) | | | | | |
| Viscosity | 1.5 or | 1.5 or | 1.5 or | 1.5 or | — |
| Ratio | more | more | less | less | |
| Breaking Strength (MPa) | 6.3 | 5.8 | 3.9 | 3.5 | 1.58 |
| Total Evaluation | ⊚ | ⊚ | X | X | — |
| of Dispersibility | | | | | |

⊚: Dispersion is quite excellent.
◯: Dispersion is excellent.
X: Dispersion is not favorable.

### Example 9

Into 5,000 ml of water at 80° C., 80 g of sodium montmorillonite (layered clay mineral manufactured by Kunimine Industries Co., Ltd.; product name: Kunipia F; total cation exchange capacity: 119 meq/100 g) were dispersed. Then, into 2,000 ml of water at 80° C., 30 g of dimethyl octadecyl (trimethyl ammonium) propyl ammonium dibromide (organizing agent) expressed by the following chemical formula (3) were dissolved, and the resulting solution was added to the montmorillonite dispersion obtained above, whereby a precipitate was obtained. This precipitate was filtered out, washed three times with water at 80° C., and then freeze-dried, whereby organized montmorillonite (hereinafter referred to as C18N2-Mt) was obtained.

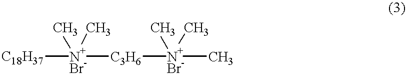

C18N2-Mt and acrylonitrile-butadiene copolymer having an acrylonitrile content of 17% (Nipol DN401 manufactured by Nippon Zeon Co., Ltd.) were mixed at 800C by use of a mill, whereby a polymer composite was obtained. The mixing ratio between acrylonitrile-butadiene copolymer and C18N2-Mt was such that the latter was 20 parts by weight with respect to 100 parts by weight of the former.

### Comparative Example 10

Into 5,000 ml of water at 80° C., 80 g of sodium montmorillonite (layered clay mineral manufactured by Kunimine Industries Co., Ltd.; product name: Kunipia F; total cation exchange capacity: 119 meq/100 g) were dispersed. Then, into 2,000 ml of water at 80° C., 36 g of octadecyl ammonium chloride (C₁₈H₃₇NH₃Cl), which was an organizing agent, were dissolved, and the resulting solution was added to the montmorillonite dispersion obtained above, whereby a precipitate was obtained. This precipitate was filtered out, washed three times with water at 80° C., and then freeze-dried, whereby organized montmorillonite (hereinafter referred to as C18-Mt) was obtained.

C18-Mt and acrylonitrile-butadiene copolymer having an acrylonitrile content of 17% (Nipol DN401 manufactured by Nippon Zeon Co., Ltd.) were mixed at 80° C. by use of a mill, whereby a mixture was obtained. The mixing ratio between acrylonitrile-butadiene copolymer and C18-Mt was such that the latter was 20 parts by weight with respect to 100 parts by weight of the former.

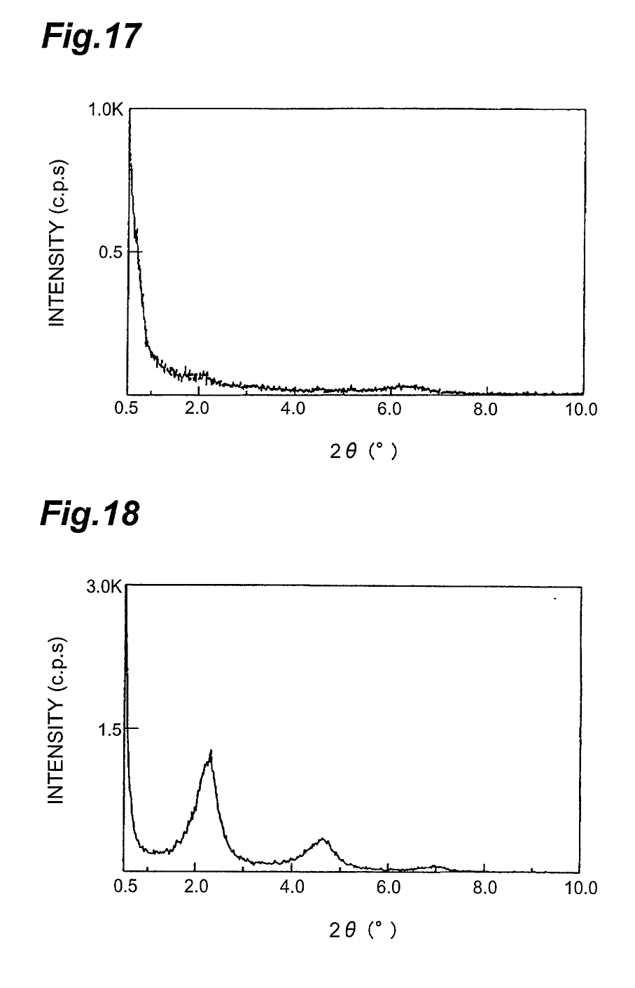

X-ray diffraction was carried out with the polymer composite obtained in Example 9 and the mixture obtained in Comparative Example 10. Thus obtained X-ray diffraction patterns are shown in FIGS. 17 and 18, respectively. No peak appeared in the X-ray diffraction pattern of FIG. 17, whereby it was seen that the layered clay mineral was dispersed as a single layer in acrylonitrile-butadiene copolymer, and the dispersibility of layered clay mineral was quite favorable. On the other hand, clear peaks appeared in the X-ray diffraction pattern of FIG. 18, whereby it was seen that the layered clay mineral in Comparative Example 10 had a layer structure to a certain extent though being dispersed in acrylonitrile-butadiene copolymer, thus yielding a dispersibility lower than that of Example 9.

As explained in the foregoing, the present invention can provide a polymer composite comprising a polymer and a layered clay mineral, in which, even when the polymer is a polar polymer, the dispersibility of layered clay mineral is favorable, and physical properties such as mechanical properties and gas barrier property are excellent.

From the invention thus described, it will be obvious that the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A polymer composite comprising a polymer and a layered clay mineral dispersed in said polymer, said layered clay mineral being a layered clay mineral organized by an organizing agent in an amount of 25% to 85% based on total cation exchange capacity of said layered clay mineral.

2. A polymer composite according to claim 1, wherein said polymer is a polymer having a solubility parameter of 9 (cal/cm³)^{½} or greater.

3. A polymer composite according to claim 1, wherein said polymer is a polymer having a nitrile group and/or a hydroxyl group.

4. A polymer composite according to claim 1, wherein said organizing agent is an organic onium compound.

5. A polymer composite according to claim 4, wherein said organic onium compound is at least one compound selected from the group consisting of an organic ammonium compound, an organic phosphonium compound, an organic pyridinium compound, and an organic sulfonium compound.

6. A polymer composite according to claim 4, wherein said organic onium compound is an organic ammonium compound comprising at least one organic chain having 4-30 carbons.

7. A polymer composite comprising a polymer and a layered clay mineral dispersed in said polymer, said layered clay mineral being a layered clay mineral organized by an organizing agent comprising an organic polyonium compound.

8. A polymer composite according to claim 7, wherein said organic polyonium compound is an organic polyonium compound having a number average molecular weight of 1000 or less, said organic polyonium compound having a content of from 5% to 25% by weight based on said organized layered clay mineral.

9. A polymer composite according to claim 7, wherein said organic polyonium compound is a compound comprising at least two onium ion atoms, an intramolecular organic chain having 1-4 carbons connecting said onium ion atoms to each other, and terminal organic chains having 1-24 carbons connected to said onium ion atoms, at least one of said terminal organic chains being an organic chain having 6-24 carbons.

10. A polymer composite according to claim 7, wherein the number of onium ion atoms in said organic polyonium compound is from 2 to 5.

11. A polymer composite according to claim 7, wherein said organic polyonium compound is a compound of the general formula (1): 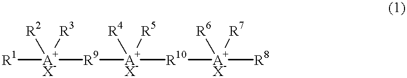
wherein A⁺ is an ion selected from the group consisting of nitrogen ion and phosphorus ion; R¹, R², R³, R⁴, R⁵, R⁶, R⁷, and R⁸ may be the same or different and each represents a member selected from the group consisting of a monovalent organic chain having 1-24 carbons and hydrogen atom, with the proviso that at least one of R¹, R², R³, R⁴, R⁵, R⁶, R⁷, and R⁸ must be a monovalent organic chain having 6-24 carbons; R⁹ and R¹⁰ may be the same or different and each represents a divalent organic chain having 1-4 carbons; and X⁻ represents an anion.

12. A polymer composite according to claim 7, wherein said organic polyonium compound is a compound of the general formula (2): 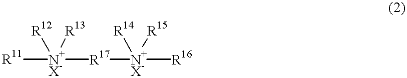
wherein R¹¹, R¹², R¹³, R¹⁴, R¹⁵, and R¹⁶ may be the same or different and each represents a member selected from the group consisting of a monovalent organic chain having 1-24 carbons and hydrogen atom, with the proviso that at least one of R¹¹, R¹², R¹³, R¹⁴, R¹⁵, and R¹⁶ must be a monovalent organic chain having 6-24 carbons; R¹⁷ is a divalent organic chain having 1-4 carbons; and X⁻ represents an anion.

13. A polymer composite according to claim 7, wherein said polymer is a polar polymer.

14. A polymer composite according to claim 7, wherein said polymer is a polymer having a solubility parameter of 9 (cal/cm³)^{½} or greater.

15. A polymer composite according to claim 7, wherein said polymer is a polymer having a nitrile group and/or a hydroxyl group.

16. A polymer composite according to claim 7, wherein said organizing agent further comprises an organic monoonium compound.
